(19) United States
(12) Patent Application Publication
(10) Pub. No.: US 2009/0019048 A1
(43) Pub. Date: Jan. 15, 2009

(54) Document lock manager

(76) Inventors: Brian S. Pendergast, East Greenwich, RI (US); Nicholas C. Croce, Old Brookville, NY (US); Richard Rupp, Plandome Manor, NY (US)

Correspondence Address: FISH & RICHARDSON P.C., P.O. BOX 1022, MINNEAPOLIS, MN, 55440-1022, US

(21) Appl. No.: 11/985,613

(22) Filed: Nov. 15, 2007

Related U.S. Application Data
(60) Provisional application No. 60/959,575, filed on Jul. 12, 2007.

(51) Int. Cl. G06F 17/30

(52) U.S. Cl. 707/8; 707/E17.007

(57) ABSTRACT

A lock manager is provided for locking documents. In some implementations, the lock manger initiates a first lock on a document that prevents other users from editing the document while it is being displayed to the user. If edits to the document are made by the user, the edits are placed in a queue for subsequent finalization, and a second lock is placed on the document. The second lock prevents other users from editing the document until the edits have been finalized.

### CLAIM OF PRIORITY

This application claims priority under 35 USC §119(e) to U.S. Provisional Patent Application Ser. No. 60/959,757, filed on Jul. 12, 2007, the entire contents of which are hereby incorporated by reference.

### TECHNICAL FIELD

This disclosure relates to a document lock manager.

### BACKGROUND

With the ever-increasing amount of electronic data held by individuals and corporations, the access and analysis of that data has increased the time and budget associated, for example, with litigation and compliance (e.g., Sarbanes-Oxley). These burdens are compounded by the recently amended U.S. Federal Rules of Civil Procedure that mandate production of Electronically Stored Information (“ESI”) and early “meet and confers” to discuss ESI. The legal and business community is therefore faced with additional pressure to manage risk and strategically manage their ESI.

To manage ESI, many have turned to electronic data mining, document review, and document management applications. These applications usually involve (1) a server that houses the ESI for review and access and (2) user terminals that are adapted to review, edit and search the ESI. The server and user terminals interface with each other via a network such as the internet, an intranet, a LAN and/or WAN. The server usually is coupled to a large data store because the amount of electronic data reviewed/produced in a litigation or generated by a corporation in its ordinary course can easily reach the terabyte (“TB”) range. Therefore, it is common for multiple persons to review, analyze and/or edit ESI simultaneously.

### SUMMARY

In an aspect of the invention, a lock manager is provided for locking documents. In some implementations, the lock manager initiates a first lock on a document that prevents other users from editing the document while it is being displayed to the user. If one or more edits to the document are made by the user, the edits are placed in a queue for subsequent finalization and a second lock is placed on the document. The second lock prevents other users from editing the document until the one or more edits have been finalized.

The details of one or more implementations are set forth in the accompanying drawings and the description below. Other features and advantages will be apparent from the description and drawings, and from the claims.

### BRIEF DESCRIPTION OF DRAWINGS

FIG. 1 is a flow chart illustrating the overall operation of an implementation of a lock manager.

FIG. 2A illustrates a first implementation of a system that includes a lock manager.

FIG. 2B illustrates a second implementation of a system that includes a lock manager.

FIGS. 3-6 illustrate example operational scenarios of an implementation of a lock manager.

FIG. 7 illustrates an example screen shot of a lock manager administrative interface.

### DETAILED DESCRIPTION

The following is a description of preferred implementations, as well as some alternative implementations, of a document lock manager.

Overview

Many electronic document management, review and analysis systems allow multiple users simultaneously to access one or more databases of documents. Documents are often stored as records (e.g., computerized files) within the database. There may be more than one record associated with a given document. For example, one record may relate to the contents of the document (e.g., the text and formatting of a word processing document) and another record may relate to the metadata associated with the document (e.g., the date the word processing document was last edited and whether it is responsive to a document request and/or attorney-client privileged).

As the data in the database may be, for example, critical corporate data, data related to a litigation and/or data that embodies expensive work product, it is desirable to maintain data integrity. Sometimes document management software is used by law firms to manage documents created for different matters. Large documents, such as motions, may represent significant monetary value in terms of legal services. Similarly, law firms and corporations employ document review and/or analysis software in the context of processing documents for litigation or compliance. Legal staff may use the software to, e.g., (1) review and categorize (e.g., privileged, non-privileged, responsive, non-responsive) documents/ESI from a client prior to production and (2) review and categorize documents/ESI produced by an adversary. The results of this processing usually represent a significant amount of legal fees due to at least the volume of documents/ESI normally produced in a litigation and the large team of legal staff that processes the documents. Therefore, it is desirable to prevent the electronic document system from causing the loss of any work product.

Many electronic document systems allow users not only to review documents, but to edit them as well. As multiple users can access the system simultaneously, the possibility arises that more than one user may attempt to edit the same document at the same time. For example, if two users try to edit the same document at the same time, there are several possible outcomes: (1) one user's edits will be overwritten by the subsequent edits of a second user; (2) both users' edits will be lost; or (3) the document will become corrupt. Regardless of the outcome, each of the two users makes its edit(s) without the benefit of knowing the other user's edit(s). At the very least, this can result in duplicated efforts and correspondingly greater costs and time. It is therefore desirable to prevent two or more users from editing the same document.

Sometimes, users edit data associated with a document rather than the contents of the document itself (e.g., so-called “metadata”). For example, if documents are being reviewed for production in litigation, users may identify the document, for example, as “responsive” and “non-privileged.” This identification does not necessarily modify the contents of the document itself, but modifies (or creates) data associated with the document. Metadata may be stored or reflected in a record that is the same or different than the one associated with the content of the document. Both the metadata record and the content record are associated with the document. In some document review and analysis applications, metadata records are stored in one partition of a database whereas records of the document contents are stored in another partition of the database. For example, in the context of documents being reviewing for production in litigation, the metadata portion of the database may include data such as whether document number X is privileged/non-privileged and responsive/non-responsive. The document contents portion of the database may include data such as the contents of document number X, e.g., the actual text of a memorandum. In some document review and analysis applications, the database is stored on several distinct servers (e.g., each partition may be on a distinct server).

Sometimes, users can be unaware that they are editing metadata. In some software applications, when users simply open a document, data associated with the document is updated to reflect the date and time the document was last accessed. In other applications, the identity of the user who last accessed or edited the document is also updated. All of these metadata should be held to the same standards of preservation and control as those associated with the contents of the document itself. Thus, it is also desirable to preserve the integrity of metadata.

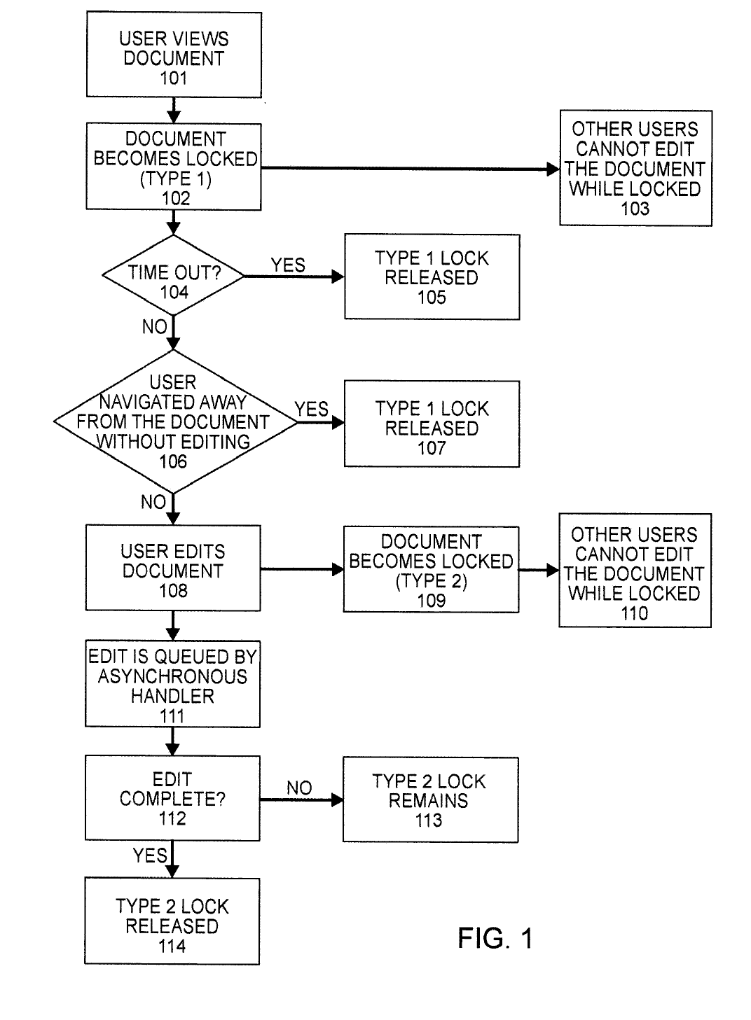

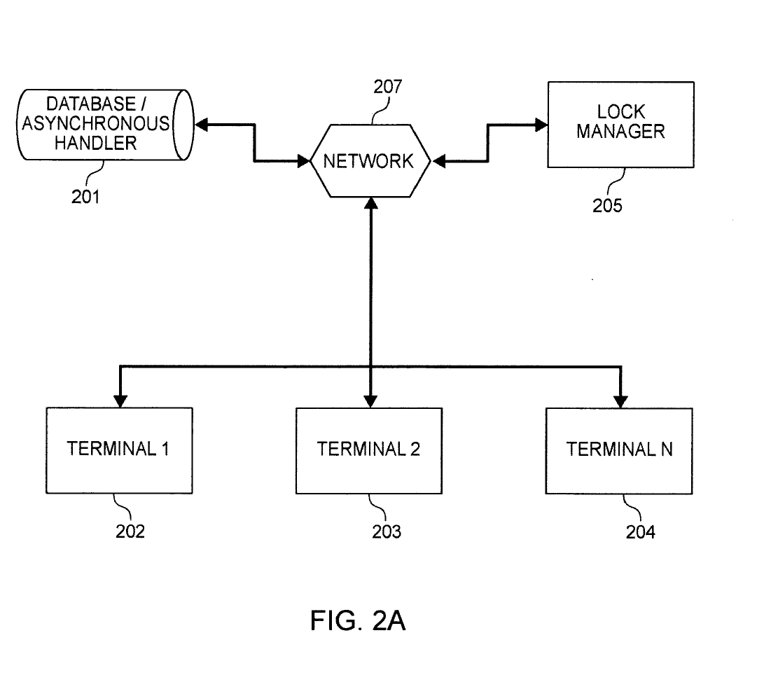

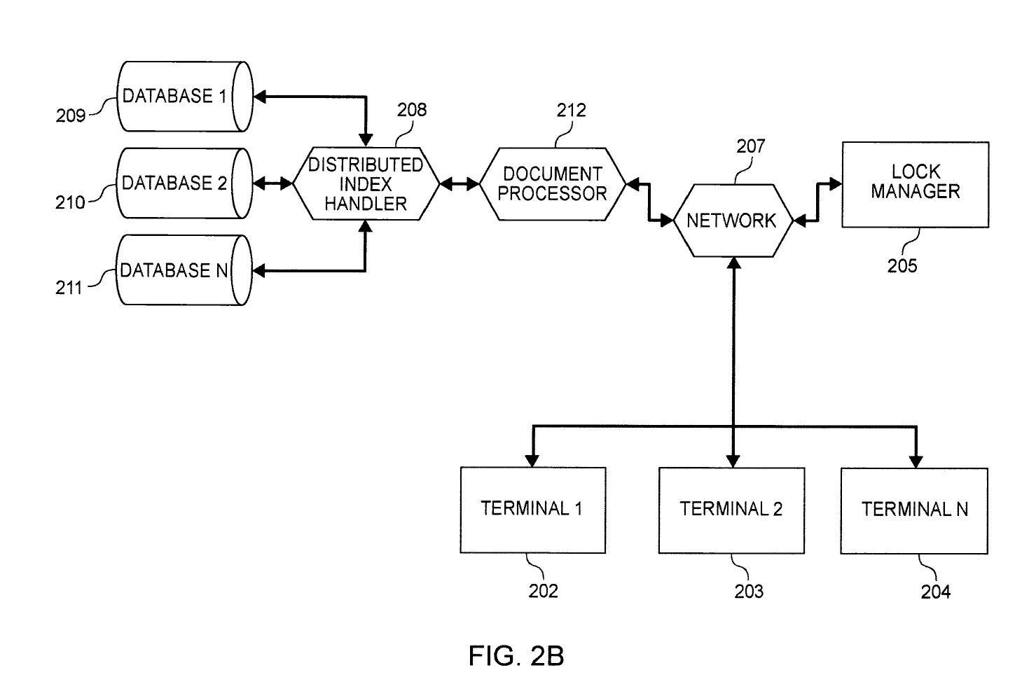

FIG. 1 provides an overview of a process for maintaining the integrity of the contents of a document and metadata by using document locks. The process can be implemented in conjunction with a database storing at least one document. In some implementations, the database is accessible by two or more users via a graphical user interface. Additional details regarding implementations of a system topology are discussed, for example, in connection with FIGS. 2A and 2B.

The process begins with a user viewing a document (101). The user views a document, for example, by opening a document from a networked database (e.g., opening a document in a word processing application) or viewing a document using document review and analysis software (e.g., reviewing documents prior to production in a litigation). Once the user has initiated viewing the document, that document receives a “type 1” lock (102). While the type 1 lock is in effect, other users cannot edit the locked document (103). In some implementations, other users are prevented from even viewing the document since, as discussed above, viewing a document may edit metadata. In some implementations, users are given the option to open a “read only” version of the locked document.

Once the type 1 lock is initiated, a time out timer begins (104). If a predetermined amount of time passes without the user interacting with the document, the type 1 lock is released (105). The predetermined amount of time can vary depending on the implementation, but examples include 15 minutes, 30 minutes or 1 hour.

It also is determined whether the user has navigated away from the document without making any edits (106). For example, a user might have closed the document after only viewing it or, in document review and analysis software, a user might choose to move on to the next document. In such an instance, the type 1 lock is released (107) so that a subsequent user is free to edit the document. In some implementations, as part of block 106, the system determines whether the user edited the contents of the document and/or the metadata associated with the document. For example, if the process is implemented with document review and analysis software, the system will detect whether the metadata has been edited (e.g., the document was tagged as “privileged”). However, if the process is implemented with a document management system (examples of document management systems include Livelink ECM-DOCS Opens by Open Text Corporation and ProLaw® by Thompson Elite), the system will detect only whether the contents of the document were edited.

If the user edits the document (108), the document receives a “type 2” lock (109), which supersedes the type 1 lock. Other users cannot edit the document while the type 2 lock is in effect. In addition, in some implementations, other users are prevented from even viewing the document because, as discussed above, viewing a document may result in editing metadata. In some implementations, users are given the option to open a “read only” version of the locked document. At block 108, depending on the implementation, the user's edit may be to the contents of the document, the metadata or both.

In some implementations, the user's edit is queued by an asynchronous handler (111). The handler places the user's edit in a queue, and updates the database on a first-in, first-out (“FIFO”) basis. The amount of time it takes to update the database will vary, for example, depending on how many other edits are in the queue, the complexity of the edit, and the size of the database. In some implementations, the user's edits are instantaneously reflected in the database. In such implementations, an asynchronous handler may be optional.

In some implementations, the edits in the queue are prioritized. For example, an administrator prioritizes edits manually or they are prioritized automatically by detecting how many times a given type 2 lock has prevented other users from editing the document. Thus, in some implementations, documents that are in higher demand can have their edits finalized on a priority basis.

The process periodically monitors whether the user's edit is complete or finalized (112), e.g., whether the database has been updated to reflect the edit. If the edit is not yet complete, the type 2 lock remains in effect (113). If the edit is complete, the type 2 lock is released (114).

Implementations of a System

FIG. 2A illustrates a first implementation of a system incorporating a lock manager 205. The lock manager 205 monitors the status of the document(s) stored in the database 201 and assigns and releases locks (both type 1 and type 2) accordingly. The lock manager 205 may be implemented, for example, as a standalone computer or server executing appropriate software. Depending on the implementation, the lock manager 205 may not require a dedicated computer or server, and instead shares processing resources with other applications. For example, the lock manager 205 and database 201 can be implemented on the same server.

The database 201 includes a data store for storing one of more documents in the form, e.g., of records and/or computer files. Depending on the implementation, the database 201 is be adapted for storing documents in connection with a document management system or a document review and analysis system. Therefore, the database 201 can store documents such as word processing documents, spreadsheets, graphics and the like. The storage capacity can vary with the implementation, and can exceed the terabyte range. As many users may simultaneously request documents from the database 201, it is adapted to allow multiple, simultaneous read and write operations. In some cases, this is accomplished, for example, by using a high-speed data store such as a RAID array.

In this implementation, the database 201 also includes the appropriate document management and/or document review and analysis software. In some implementations, the document processing software is loaded on a separate server, and in other implementations, the document processing software and the document database are incorporated onto the same server. The database 201 also may include an asynchronous handler for queuing a user's edit(s) into batches for subsequent finalization. The asynchronous handler generates identification data for each batch of edit(s) and monitors the database 201 to determine when the batch has been finalized.

The lock manager 205 and database 201 communicate via a network 207. Some implementations couple the lock manager 205 and database 201, e.g., by a direct connection or integration on one server. In some implementations, the database 201 and the lock manager 205 communicate via TCP/IP (e.g., a dedicated TCP socket). Other protocols and interfaces can be effective in various implementations. The network 207 can take the form of a LAN, WAN, VPN, wireless network, wired network, PSTN, and/or the internet.

Any number of terminals (e.g., 202-204) can be coupled to the network 207 for access to the database 201. For example, Terminal 1 (202) can execute browser software to interface with document review and analysis software that is being executed (at least in part) by the database 201. The user at Terminal 1 (202), for example, reviews and analyzes documents that are stored on the database 201 and views and modifies metadata associated with those documents on the database 201.

Terminal 2 (203), for example, can execute word processing software to interface with document management software that is being executed (e.g., at least in part) by the database 201. The user at Terminal 2 (203), for example, searches for, opens, and edits documents that are stored on the database 201. In some implementations, the database 201 is partitioned such that Terminal 1 (202) and Terminal 2 (203) have access to different sets of documents. In some implementations, different documents are available depending on whether the terminal is executing document management or document review and analysis software. In some implementations, the database 201 is not partitioned, and all terminals have access to the same set of documents.

The lock manager 205 monitors the activity between the terminals (e.g., 202-204) and the database 201. When the system provides a document from the database for display on a terminal associated with a user 201, the lock manager 205 initiates a type 1 lock. The lock manager also initiates monitoring of the type 1 lock and the user's activity within the document. For example, the lock manager 205 initiates a timer that will automatically release the type 1 lock after a predetermined time if the user does not interact with the document. Also, the lock manager can release the type 1 lock if the user closes the document without making edits.

If the user edits a document, the lock manager 205 initiates a type 2 lock. Since, in some implementations, type 2 locks are not released until the database 201 has been updated to reflect the batch of edit(s), the lock manager 205, by way of the asynchronous handler, monitors the status of the batch. If the database 201 has been updated appropriately, the lock manager 205 releases the type 2 lock. The asynchronous handler of the database 201 (e.g., in communication with the lock manager 205) can generate a notification (e.g., a replication flag) that indicates when the batch is finalized. The replication flag can include a field that identifies what batch is finalized (including, e.g., which edit, which document, which user, which terminal and/or which database). The lock manager 205 utilizes the replication flag to determine whether the type 2 lock should be released for a particular batch associated with a particular document.

FIG. 2B illustrates a second implementation of a system incorporating a lock manager 205. The lock manager 205 monitors the status of the document(s) stored in the databases 209-211 and assigns and releases locks (both type 1 and type 2) accordingly. The lock manager 205 may be implemented, for example, as a standalone computer or server executing appropriate software. Depending on the implementation, the lock manager 205 does not require a dedicated computer or server, and may share processing resources with other applications. For example, the lock manager 205, document processor 212 and distributed index handler 208 can be implemented on the same server.

The databases 209-211 include a data store for storing one of more documents, e.g., in the form of records and/or computer files. Each database 209, 210 and 211 can be assigned to different applications or users. The storage capacity of the databases 209-211 can vary with the implementation, and can exceed the terabyte range. As many users may request documents from the databases 209-211 simultaneously, they are adapted to allow multiple, simultaneous read and write operations. This can be accomplished, for example, by using a high-speed data store such as a RAID array. In some cases, databases 209-211 are located on the same premises, and in other cases are remote from each other.

In this implementation, access to the individual databases 209-211 is coordinated by a distributed index handler 208, which takes the form of hardware and/or software. The distributed index handler 208 can be used, for example, (1) to coordinate requests from users (e.g., at terminals 202-204) to ensure that requests are handled by the appropriate database and (2) to ensure that locks from the lock manager 205 are applied to the appropriate repository. In this implementation, the document processor 212 and distributed index handler 208 communicate via a secure connection. This may be done to increase security. However, in other implementations, the handler 208 and databases 209-211 may be coupled directly to the network 207.

In this implementation, the appropriate document management and/or document review and analysis software is executed on a dedicated processor 212 that interfaces, via the distributed index handler 208, with the databases 208. The handler 208 operates in conjunction with the document processor 212 to ensure that appropriate documents within the databases 209-211 are made available for processing by the document processor 212. For example, certain documents stored in Database 2 (201) may have been collected for possible production in a litigation (e.g., “Litigation A”). When a user interfaces with the document processor 212 and indicates that she wishes to review documents in connection with Litigation A, the document processor 212 and handler 208 ensure that the user is given access to the appropriate documents stored in Database 2 and associated with Litigation A.

An asynchronous handler can be integrated with, e.g., items 208, 209-211 and/or 212.

In some implementations, the document processor 212 is off-site relative to the databases 209-211, or in other implementations is local. The document processor 212 can execute several different software applications to allow different users to execute document management and/or document review and analysis software. In some implementations, regardless of how many different applications and databases are employed, a single lock manager 205 is used. However, in some high-volume implementations, it may be desirable to utilize multiple lock managers 205 running on dedicated processors.

The lock manager 205 and database 201 communicate via a network 207. Some implementations can couple the lock manager 205 and database 201, e.g., by a direct connection or integration on one server. In some implementations, the databases 209-211, handler 208, document processor 212 and the lock manager 205 communicate via TCP/IP (e.g., a dedicated TCP socket). Other protocols and interfaces can be effective in various implementations.

Any number of terminals (e.g., 202-204) can be coupled to the network 207 for access to the databases 209-211. For example, Terminal 1 (202) can execute browser software to interface with document review and analysis software that is being executed (e.g., at least in part) by the document processor 212 with respect to documents stored on database 209. The user at Terminal 1 (202), for example, can review and analyze documents that are stored on the database 209 and view and modify metadata associated with those documents on the database 209.

Terminal 2 (203), for example, can execute word processing software to interface with document management software that is being executed (e.g., at least in part) by the document processor 212 with respect to documents stored on database 210. The user at Terminal 2 (203), for example, can search for, open, and edit documents that are stored on the database 210.

In some implementations, each database 209-211 is partitioned such that the terminals (202), (203), (204) have access to different sets of documents. In some implementations, different documents are available to a terminal depending on whether the document processor 212 is executing document management or document review and analysis software for that terminal. In some implementations, the databases 209-211 are not partitioned, and all terminals have access to the same set of documents regardless of the application.

The lock manager 205 monitors the activity between the terminals (e.g., 202-204) and the databases 209-211. When the system provides a document from the database for display on a terminal associated with a user, e.g., from Database 1 (209), the lock manager 205 initiates a type 1 lock. The lock manager also initiates monitoring of the type 1 lock and the user's activity within the document. For example, the lock manager 205 initiates a timer that will automatically release the lock after a predetermined time period of inactivity. Also, the lock manager can release the type 1 lock if the user closes the document without making edits.

If the user edits a document, the lock manager 205 initiates a type 2 lock. Since, in some implementations, type 2 locks are not released until the database 209 has been updated to reflect the user's batch of edit(s), the lock manager 205, by way of the asynchronous handler, monitors the status of the batch. If the database 209 has been updated appropriately, the lock manager 205 releases the type 2 lock. The asynchronous handler associated with the database 209 (e.g., in communication with the lock manager 205) may generate a notification that indicates when the batch is finalized. The replication flag can include a field that identifies what batch is complete (including, e.g., which edit, which document, which user, which terminal and/or which database). The lock manager 205 utilizes the replication flag to determine whether the type 2 lock should be released for a particular batch associated with a particular document.

Examples of Operation of a Lock Manager

For purposes of the following examples, the user may be operating any appropriate type of terminal (e.g., items 202-204 of FIGS. 2A and 2B) and interfacing with one or more databases that store documents (e.g., item 201 of FIG. 2A or items 209-211 of FIG. 2B). In these examples, the database and/or document processor is executing document review and analysis software, but in other implementations document management software may be executed. The lock manager (e.g., item 205 of FIGS. 2A and 2B) can take the form of a separate server or may be integrated with another server or processor.

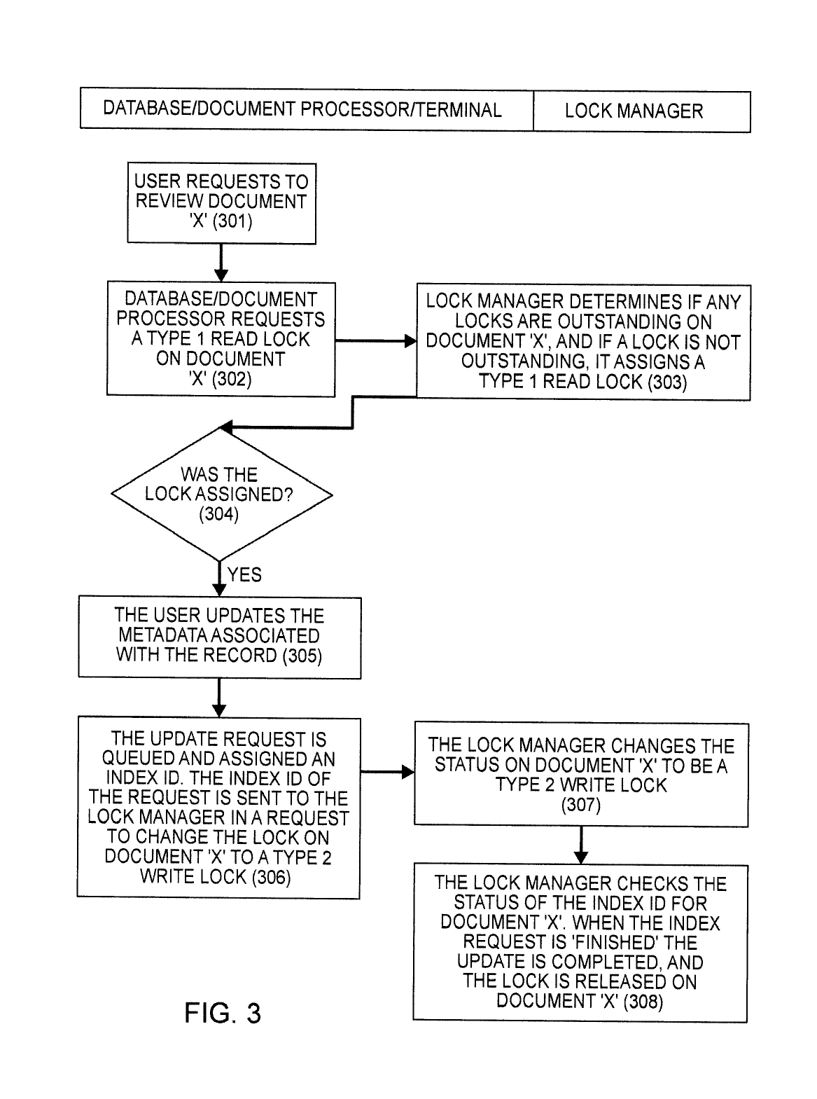

FIG. 3 illustrates a first example scenario of a user interfacing with a database of documents, and indicates how the lock manager mediates that interface. As shown in the heading, processing that occurs predominately in connection with the database, document processor and/or terminal are shown on the left whereas processing that occurs predominately in connection with the lock manager are shown on the right.

In this example, the user is attempting to review and possibly edit a record associated with a document in the database. For example, the user makes a request (e.g., via a terminal) to review document “x” (301). Document x can be, for example, a document produced by an adversary in a litigation, and the user may desire to review it for the purpose of, e.g., categorizing and/or annotating it. After the user makes her request (301), the database and/or document processor requests a type 1 read lock on document x (302). The lock manager determines whether any locks are outstanding on document x (303). If there are outstanding locks on the document, it means, for example, that some other user may be viewing the document or that another user edited the document and the edits have not yet been replicated. If there are no outstanding locks, the lock manager assigns a type 1 read lock (303). Typically, the type 1 read lock will expire or timeout after a given period of inactivity (e.g., 30 minutes). A lock “keep alive” manager resets the time period based on user activity (e.g., the 30 minute clock is reset each time the user interacts with the database and/or document processor).

The lock manager transmits a signal that allows the database and/or document processor to determine whether the type 1 lock was assigned (304). In this example, there were no outstanding locks on document x, and a type 1 lock was assigned. Accordingly, the user updates the metadata on the record associated with the document (305). For example, the user might have identified a particular document as being relevant to the issue of liability by clicking a box labeled “liability” and/or entering open-ended comments.

The database and/or document processor places the user's edit(s) in queue and assigns it an index ID (306). In some implementations, edits made by a user in the course of the same type 1 lock are placed together in the queue as one batch. Thus, a user's edit(s) made within a signal instance of viewing the document can be placed in the queue as one batch. In some implementations, a user's edits are not placed in the queue until she clicks a “save” button or otherwise indicates that she has completed making edits. The index ID is transmitted to the lock manager along with a request to change the lock on document x to a type 2 write lock (306). Accordingly, the lock manager changes the status of the lock to a type 2 lock (307). The lock manager then periodically checks the status of the index ID associated with document x (308) by communicating with the asynchronous handler. When the lock manager detects that the index request is finished (e.g., the batch is finalized), the lock is released on document x (308). In some implementations, the user may continue to edit document x even after her edits have been placed in the queue so long as the user has not closed document x. In that instance, the type 2 lock does not prevent the user from editing document x.

In some implementations, multiple locks (type 1 and/or type 2) are associated with a single user if that user has multiple documents open. In some implementations, the type 1 locks expire on a per-user basis rather than a per-document basis. For example, the lock manager determines whether the user has been active within the last 30 minutes irrespective of which open document the user is reviewing. Therefore, in those implementations, the type 1 lock for all of a user's open documents will expire substantially simultaneously.

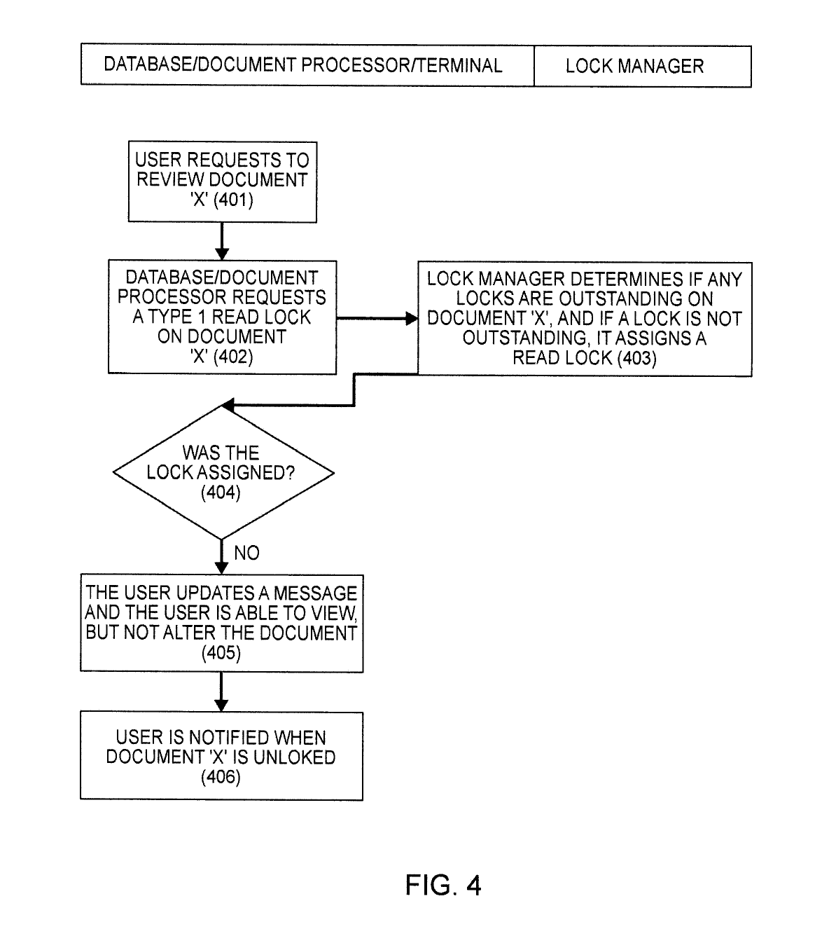

FIG. 4 illustrates a second example scenario of a user interfacing with a database of documents, and indicates how the lock manager mediates that interface. As shown in the heading, processing that occurs predominately in connection with the database, document processor and/or terminal are shown on the left whereas processing that occurs predominately in connection with the lock manager are shown on the right.

In this example, the user is attempting to review and possibly edit a record associated with a document in the database, but that document currently is being viewed or edited by another user. For example, the user makes a request (e.g., via a terminal) to review a given document “x” (401). After the user makes her request (401), the database and/or document processor requests a type 1 read lock on document x (402). The lock manager determines whether any locks are outstanding on document x (403). If there are outstanding locks on the document, it means, for example, that some other user may be viewing the document or that another user edited the document and the edits have not yet been replicated. If there are no outstanding locks, the lock manager assigns a type 1 read lock (403).

The lock manager transmits a signal that allows the database and/or document processor to determine whether the type 1 lock was assigned (404). In this example, there was an outstanding lock on document x, and a type 1 lock was not assigned to the user. Accordingly, the user may not alter the document (including, e.g., the metadata associated with the document), but is allowed to view the document (405). Also, the user is issued a message that, for example, identifies the user who currently is viewing the document and/or has edits outstanding (405). The message that the user receives can be based on communication between the database/document processor and the lock manager.

In some implementations, the user may instruct the database and/or document processor to check the status of document x periodically and notify the user when it is available for editing (406). The user may receive the notification, for example, by email, telephone, or instant message.

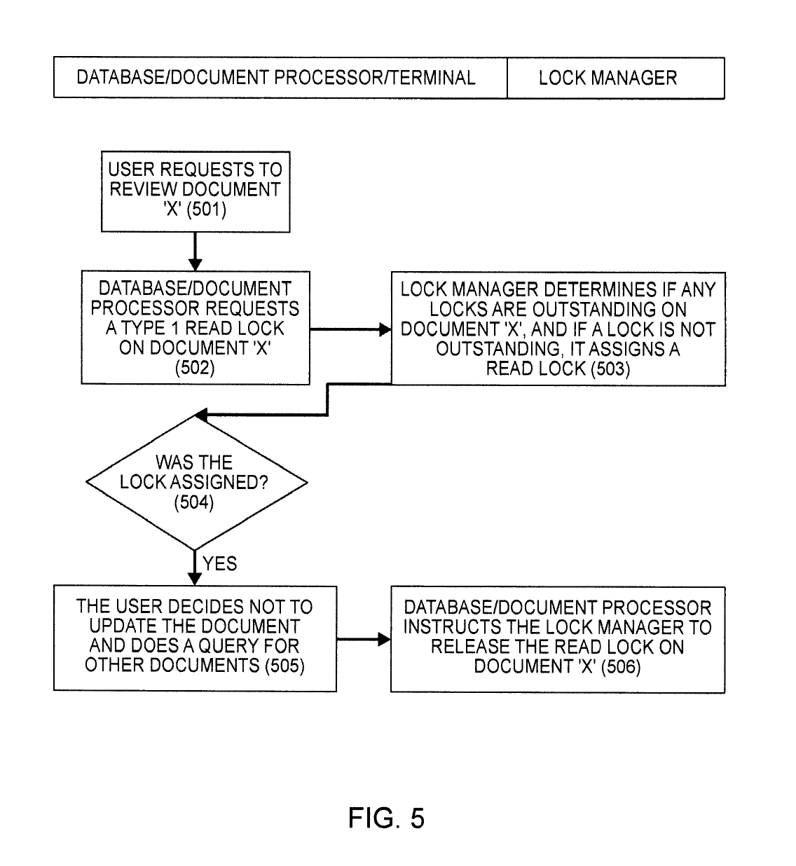

FIG. 5 illustrates a third example scenario of a user interfacing with a database of documents, and indicates how the lock manager mediates that interface. As shown in the heading, processing that occurs predominately in connection with the database, document processor and/or terminal are shown on the left whereas processing that occurs predominately in connection with the lock manager are shown on the right.

In this example, the user is attempting to review and possibly edit a record associated with a document in the database, but discards the edit and closes the document. The user makes a request (e.g., via a terminal) to review a given document “x” (501). After the user makes her request (501), the database and/or document processor requests a type 1 read lock on document x (502). The lock manager determines whether any locks are outstanding on document x (503). If there are outstanding locks on the document, it means, for example, that some other user may be viewing the document or that another user edited the document and the edits have not yet been replicated. If there are no outstanding locks, the lock manager assigns a type 1 read lock (503).

The lock manager transmits a signal that allows the database and/or document processor to determine whether the type 1 lock was assigned (504). In this example, there were no outstanding locks on document x, and a type 1 lock was assigned to the user. Here, the user decides not to edit document x, and closes it by doing a query for other documents (505). A user may close a document in several ways including, e.g., logging off the database and/or document processor, closing a web browser window or application window associated with document review and analysis software, or manually instructing the document review and analysis software to close document x (e.g., clicking a button or menu item labeled “close”). The database and/or document processor transmits a signal to the lock manager indicating that document x has been closed. In response to that signal, the lock manager releases the type 1 lock on document x (506). Thus, when a user navigates away from document x which has not been edited, the type 1 lock on document x associated with that user is released.

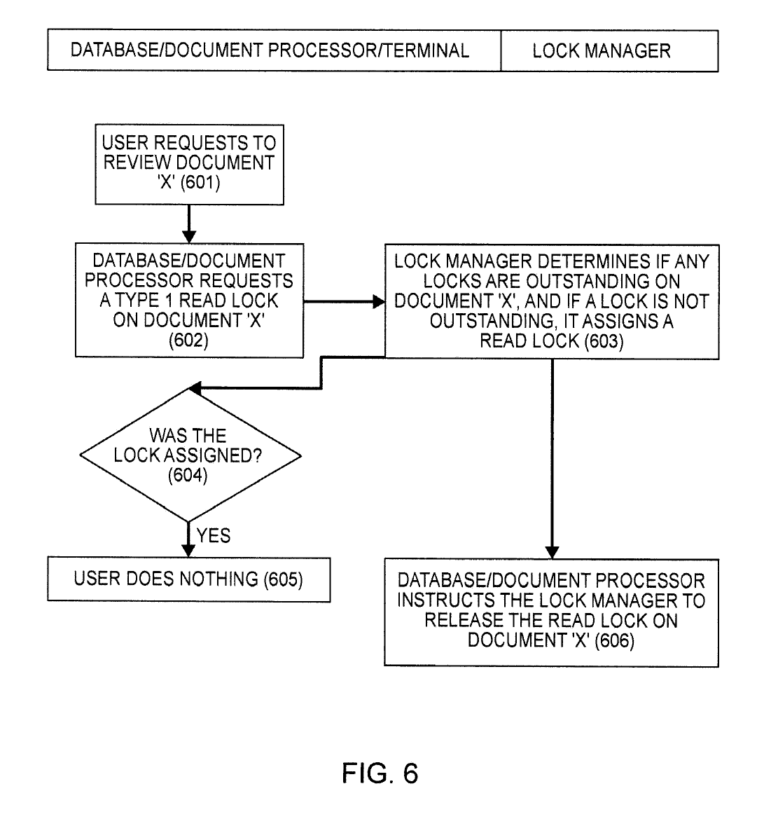

FIG. 6 illustrates a fourth example scenario of a user interfacing with a database of documents, and indicates how the lock manager mediates that interface. As shown in the heading, processing that occurs predominately in connection with the database, document processor and/or terminal are shown on the left whereas processing that occurs predominately in connection with the lock manager are shown on the right.

In this example, the user is attempting to review and possibly edit a record associated with a document in the database, but the user turns off her computer or loses connection with the database/document processor before making any edits. The user makes a request (e.g., via a terminal) to review a given document “x” (601). After the user makes her request (601), the database and/or document processor requests a type 1 read lock on document x (602). The lock manager determines whether any locks are outstanding on document x (603). If there are outstanding locks on the document, it may be because some other user is viewing the document or that another user edited the document and the edits have not yet been replicated. If there are no outstanding locks, the lock manager assigns a type 1 read lock (603).

The lock manager transmits a signal that allows the database and/or document processor to determine whether the type 1 lock was assigned (604). In this example, there were no outstanding locks on document x, and a type 1 lock was assigned to the user. The user does not interact with the database and/or document processor because, e.g., she turns off her computer or loses connection with the database and/or document processor (605). After a predetermined period of inactivity, the database and/or document processor sends a instruction to the lock manager to release the type 1 lock on document x.

Administration of the Lock Manager

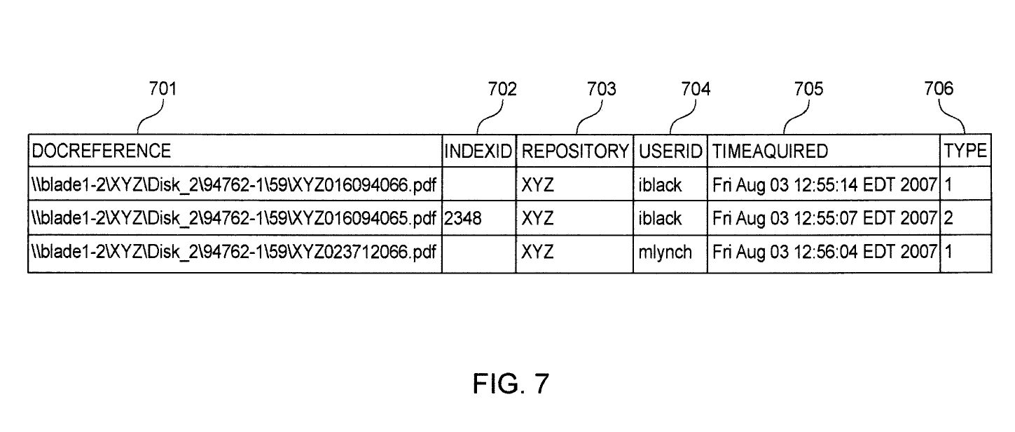

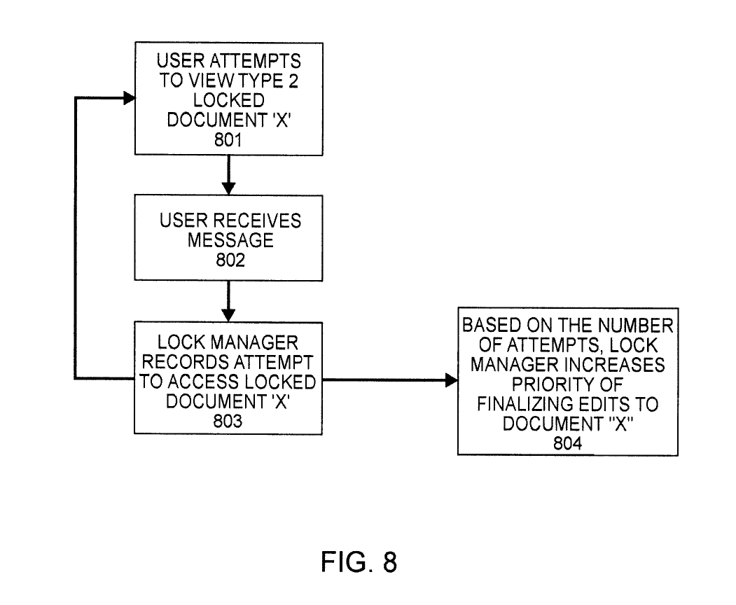

At times, it may be desirable for an administrator to view or edit the status of open locks (both type 1 and type 2). The status of open locks can be viewed by way of the lock manager administrative interface, an example screen shot of which is illustrated in FIG. 7. In some implementations, this information is available in this form to all users, but can be edited only by an administrator.

The identity of the document is displayed in field 701. In this example, the document is identified by its filename and path. In other implementations, the document could also be identified by user-created comments or categories. The index ID, if any, is displayed in field 702. The index ID is associated with one or more edits made by a user and is used to track whether those edits have been finalized (e.g., replicated). Therefore, index IDs are assigned in connection only with type 2 locks. In some implementations, type 2 locks are released once the associated edits have been replicated. Once an edit is replicated, a subsequent user who accesses the document will view the document with the user's edits incorporated. In some implementations, replication occurs on an asynchronous basis, e.g., not at the same time edits are made or saved by the user.

The repository or database in which the document is stored is displayed in field 703. The repositories may identify particular databases or may be user-created categories in which documents are stored. For example, in a document management system, documents for a New York office can be stored in a “NY” repository whereas documents for a San Francisco office can be stored in a “SF” repository. In a document review and analysis system, documents may be stored in different repositories that reflect, e.g., the business unit from which they were collected (e.g., “Eng” for engineering), the party that produced the documents (e.g., “Pl” for plaintiff), the subject matter to which the documents relate (e.g., “Liability” for liability-related documents), or the date on which they were received, collected or produced.

The identity of the user associated with the lock is provided in field 704. This identity data may be provided to a user who attempts to view a locked document (see, e.g., block 405 of FIG. 4). As shown in FIG. 7, user “iblack” has two open locks, one of which is a type 1 and the other is a type 2. In some implementations, field 704 can identify the terminal with which the lock is associated. The time that the lock was acquired is shown in field 705. The lock type is shown in field 706. The time acquired and lock type data may be provided to a user who attempts to view a locked document (see, e.g., block 405 of FIG. 4).

Knowing the lock type and the identity of the user who has the open lock can assist another user expedite release of the lock. For the type 1 lock, the user can contact “iblack” and inquire whether she intends to continue viewing (and possibly edit) the document. If “iblack” does not so intend, “iblack” can move on to another document, thereby releasing the type 1 lock. For the type 2 lock, “iblack” has less control over its release. As the type 2 lock is dependent upon the system finalizing “iblack”'s edits, there is little that “iblack” can do to hasten release of the lock.

However, some implementations may allow users or administrators to increase the priority of an edit such that is it replicated more quickly, thereby releasing the type 2 lock sooner. For example, the database/document processor may track attempts to access a document that has a type 2 lock. It may then automatically increase the priority of finalizing an edit based on how many attempts are made to access the type 2 locked document. For example, the more attempts there are to access the document, the higher the priority of the edit. FIG. 8 illustrates an implementation of such a process. Each time a user attempts to view type 2 locked document “X” (801), she receives a message that informs her of the document status (802). The lock manager can record each instance that a user attempts to access the type 2 locked document (803), e.g., blocks 801-803 may proceed several times for various users who attempt to access document “X”. Based on the number of attempts to access the type 2 locked document, the lock manager increases priority of finalizing edits to document “X.”

In some implementations, an administrator can edit the information illustrated in FIG. 7. For example, if a user closes a document, but for some reason the type 1 lock does not release, the administrator can click the lock in question and delete it (e.g., by pressing the “delete” on a keyboard coupled to a terminal). Also, the administrator might choose to delete type 1 locks that are too old (e.g., over 5 hours) on the assumption that an error is to blame since a user would probably not view a document for five hours without editing it.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

A number of implementations have been described. Nevertheless, it will be understood that various modifications may be made without departing from the spirit and scope of the invention. For example, the lock manager can be implemented with a document management system and/or a document review and analysis system. Accordingly, other embodiments are within the scope of the claims.

What is claimed is:

1. A system for locking records associated with documents comprising:
a database coupled to two or more user terminals, each user terminal being adapted for a user to review and edit a record associated with a document stored in the database, wherein the database is adapted to generate a review notification in response to an instance in which the record is being reviewed, the review notification comprising data that identifies the record and the user or user terminal reviewing the record;
an asynchronous handler coupled to the database to place a batch of one or more edits to the record made by a user in a queue for subsequent finalization, the asynchronous handler being further adapted to generate an identifier for each respective batch and to generate a completion signal when each respective batch is finalized;
a lock manager, coupled to the database and the asynchronous handler, adapted to:
receive the review notification generated by the database and, in instances in which a first user is reviewing the record, initiate a first lock on the record that prevents a second user from editing the record; and
receive the identifier generated by the asynchronous handler and, in instances in which the batch is associated with edits made by the first user, initiate a second lock on the record that prevents the second user from editing the record until the completion signal associated with the first user's batch is detected.

2. The system of claim 1 wherein the asynchronous handler is adapted to generate a completion signal in response to communication between the asynchronous handler and the database.

3. The system of claim 1 wherein a record comprises contents of the document.

4. The system of claim 1 wherein a record comprises metadata.

5. The system of claim 1 wherein the database and the two or more terminals are adapted to communicate via the internet.

6. The system of claim 1 wherein the database and the asynchronous handler comprise one or more server computers.

7. The system of claim 6 wherein the one or more server computers comprise document management software or document review and analysis software.

8. The system of claim 1 wherein the lock manager is adapted to:
count the number of instances in which the second lock on the record prevents a user from editing the record; and
based on the number of instances, cause the priority of finalizing the first user's batch to increase in the queue.

9. A computer-implemented method for locking documents comprising:
receiving an electronic request from a first user to review an electronic record associated with a document;
determining that the record is unlocked;
displaying the record to the first user;
initiating a first lock on the record that prevents other users from editing the record while the record is being displayed to the first user;
wherein if one or more edits to the record are received from the first user,
placing the one or more edits in a queue for subsequent finalization; and
initiating a second lock on the record, in response to receiving the one or more edits, that prevents other users from editing the record until the one or more edits have been finalized.

10. The method of claim 9 comprising:
automatically releasing the first lock after a predetermined period of inactivity by the first user.

11. The method of claim 9 comprising:
releasing the first lock if the record is no longer being displayed to the first user and no edits to the record have been received from the first user.

12. The method of claim 9 comprising:
receiving an electronic request from a second user to review the record;
determining that the record is locked;
displaying a message to the second user that indicates the record is locked.

13. The method of claim 12 comprising:
notifying the second user when the record is unlocked.

14. The method of claim 12 wherein the message comprises the identity of the user whose activity related to initiating the first lock or second lock on the record.

15. The method of claim 9 wherein the one or more edits are made to the content of the document.

16. The method of claim 9 wherein the one or more edits are made to metadata associated with the document.

17. The method of claim 9 comprising:
counting the number of instances in which the second lock on the record prevents other users from editing the record; and
based on the number of instances, causing the priority of finalizing the one or more edits to increase in the queue.

18. A computer-implemented method for mediating access by a plurality of users to records associated with documents stored in one or more databases, the method comprising:
receiving a request from a first user to display a record associated with a document stored in the database;
generating a display notification when the record is displayed, the display notification comprising data that identifies the record and the user that requested the record;
receiving from the first user a batch of one or more edits to the record;
placing the batch of one or more edits in a queue for subsequent finalization;
generating an identifier for each respective batch;
generating a completion signal when each respective batch is finalized;
initiating, in response to a display notification that identifies the record and the first user, a first lock on the record that prevents a second user from editing the record; and
initiating, in response to an identifier that identifies a batch of edits made by the first user, a second lock on the record that prevents the second user from editing the record until the completion signal associated with the first user's batch is detected.

19. The method of claim 17 wherein the batch comprises one or more edits to the record made by the first user in a single instance of displaying the record.

20. The method of claim 17 wherein generating a completion signal comprises communicating with the database.

21. The method of claim 17 wherein the one or more edits are made to metadata associated with the document.

22. An article comprising a machine-readable medium that stores machine-executable instructions for causing a machine to:
receive an electronic request from a first user to review an electronic record associated with a document;
determine that the record is unlocked;
display the record to the first user;
initiate a first lock on the record that prevents other users from editing the record while the record is being displayed to the first user;
wherein if one or more edits to the record are received from the first user,
place the one or more edits in a queue for subsequent finalization; and
initiate a second lock on the record, in response to receiving the one or more edits, that prevents other users from editing the record until the one or more edits have been finalized.

23. The article of claim 22, further causing a machine to:
receive an electronic request from a second user to review the record;
determine that the record is locked; and
display a message to the second user that indicates the record is locked.

24. The article of claim 23, further causing a machine to:
notify the second user when the record is unlocked.

25. The article of claim 22 wherein the one or more edits are made to the content of the document.

26. The article of claim 22 wherein the one or more edits are made to metadata associated with the document.

27. The article of claim 22, further causing a machine to:
count the number of instances in which the second lock on the record prevents other users from editing the record; and
based on the number of instances, cause the priority of finalizing the one or more edits to increase in the queue.
